(19) United States
(12) Patent Application Publication
(10) Pub. No.: US 2026/0259166 A1
(43) Pub. Date: Sep. 3, 2026

(54) GLUCOSE-SENSING DEVICE AND METHOD OF FABRICATING THE SAME

(71) Applicant: Ming Chi University of Technology, New Taipei City (TW)

(72) Inventors: Mani GOVINDASAMY, New Taipei City (TW); Sheng-Chi CHEN, New Taipei City (TW); Nishchal PARDHI, New Taipei City (TW); Shikha Akshay JOSHI, New Taipei City (TW)

(21) Appl. No.: 19/190,177

(22) Filed: Apr. 25, 2025

(30) Foreign Application Priority Data
Mar. 3, 2025 (TW) 114107776

(51) Int. Cl. G01N 27/30

(52) U.S. Cl. CPC G01N 27/30

(57) ABSTRACT

A glucose-sensing device includes an insulative substrate, a metal oxide conductive layer, a transition metal nitride layer, and an insulative layer. The metal oxide conductive layer is formed on the upper surface of the insulative substrate and has a working electrode area and a terminal area. The transition metal nitride layer is locally formed to overlay the working electrode area of the metal oxide conductive layer. The insulative layer is locally formed on the metal oxide conductive layer to expose the transition metal nitride layer and the terminal area.

### CROSS-REFERENCE TO RELATED APPLICATION

This utility application claims priority to Taiwan Application Serial Number 114107776, filed Mar. 3, 2025, which is incorporated herein by reference.

Regarding the relevant technical background of this present invention, please refer to the references listed below:
[1] D. Yin, X. Bo, J. Liu, L. Guo, A novel enzyme-free glucose and H₂O₂ sensor based on 3D graphene aerogels decorated with Ni₃N nanoparticles, Anal. Chim. Acta. 1038 (2018) 11-20, https://doi.org/10.1016/j.aca.2018.06.086.
[2] F. Xie, T. Liu, L. Xie, X. Sun, Y. Luo, Metallic nickel nitride nanosheet: an efficient catalyst electrode for sensitive and selective non-enzymatic glucose sensing, Sens Actuators B Chem. 255 (2018) 2794-2799, https://doi.org/10.1016/j.snb.2017.09.095.
[3] J. Chen, H. Y in, J. Zhou, J. Gong, L. Wang, Y. Zheng, Q. Nie, Non-enzymatic glucose sensor based on nickel nitride decorated nitrogen-doped carbon spheres (Ni₃N/NCS) via facile one pot nitridation process, J. Alloys Compd. 797 (2019) 922-930, https://doi.org/10.1016/j.jallcom.2019.05.234.
[4] X. Dai, W. Deng, C. You, Z. Shen, X. Xiong, X. Sun, A Ni₃N—Co₃N hybrid nanowire array electrode for high-performance nonenzymatic glucose detection, A nal. Methods 10 (2018) 1680-1684, https://doi.org/10.1039/C8A Y 00370J.
[5] J. Chen, H. Y in, J. Zhou, L. Wang, Z. Ji . . . , Y. Zheng, Q. Nie, Hybrid Ni₃N-nitrogen-doped carbon microspheres (Ni₃N@C) in situ derived from Ni-M OFs as sensitive non-enzymatic glucose sensors, Material Technology vol. 36 (2021) 286-295, https://doi.org/10.1080/10667857.2020.1751471.
[6] J. Luo, D. Zhao, M. Y ang, F. Qu, Porous Ni₃N nanosheet array as a catalyst for nonenzymatic amperometric determination of glucose, Microchim. Acta. 185 (2018) 229, https://doi.org/10.1007/s00604-018-2764-z.

### BACKGROUND OF THE INVENTION

### 1. Field of the Invention

The invention relates to a glucose-sensing device and a method of fabricating the same, and more particularly, to a glucose-sensing device with higher sensitivity and a wider linear sensing range, as well as a method of fabricating the same.

### 2 Description of the Prior Art

Regarding glucose-sensing devices of the prior arts, high catalytic activities offered by the noble metals and their metal alloys help in efficient glucose detection, and they have been used on a large scale in non-enzymatic glucose-sensing devices. However, there is a limitation in using these noble metals because of their higher cost. As a result, it is of great need and interest to develop cost-effective and earth-abundant nanostructures for sensing purposes. In the race to find a replacement for noble metal and their alloys, metal nitrides emerge as an efficient solution. Several transition metal nitrides possess various crystallographic phases, for example, the Iron Nitride (Fe—N) system shows the Fe₁₆N₂, Fe₃N, FeN, and FeN₄. Likewise, Cobalt Nitride (Co—N) also has been found in several forms, Co₄N, Co₂N, and CoN. Interestingly, Nickel Nitride (Ni—N) is the transition metal nitride that needs to be explored. Metal nitrides have various advantageous properties such as easy operation, excellent catalytic activity, and corrosion resistance. These systems provide a higher electron density near the fermi level, faster charge-carrier transportation, and enhanced electrical conductivity, making them more suitable for electrochemical sensors.

Among various metal nitrides, Ni₃N has attracted the tremendous interest of researchers because of its stable hexagonal phase at room temperature. Ni₃N possesses a phase like ε—Fe₃N. The nitrogen atom occupies the octahedral site of the unit cell, which results in the minimum repulsive energy between two nitrogen atoms. Hence, nickel nitride (Ni₃N) can be characterized as an interstitial metallic compound, where nitrogen atoms are positioned within the interstices. The first principal calculation studies revealed less formation energy of hexagonal Ni₃N (+32.9 meV/atom).

Ni-based compounds like oxides, hydroxides, and nitrides are found to be the widely used systems as sensors. However, oxides and hydroxides lack performance because of their lower conductivity. Thus, the development of highly conductive Ni-based compounds for glucose sensing is in high demand. To figure out this shortcoming, Ni₃N as a material emerged as a potential candidate because of its high catalytic activity and high conductivity. Several researchers have attempted to explore the material to fabricate a sensor supported with another conductive material.

Regarding sensing devices utilizing Ni₃N of prior arts, one prior art [1] has fabricated Ni₃N nanoparticles with 3D graphene aerogel using a hydrothermal synthesis process. The fabricated sensing device exhibited a wide linear range of 0.1 to 7645.3 μM, a rapid response time of 3 seconds, high sensitivity of 905.6 μAmM⁻¹ cm⁻², and a low detection limit of 0.04 μM. However, the stability of the sensing device of the prior art has very little day stability.

Another prior art [2] illustrates the fabrication of Ni₃N nanosheets on Ti mesh to form a working electrode of a sensing device. The sensing device exhibits a linear range of 0.2 μM to 1.5 mM, a response time within 5 seconds, sensitivity of 7688 μAmM⁻¹ cm⁻², and a detection limit of 0.06 μM.

Another prior art [3] has used the nitridation process to synthesize the Ni₃N decorated nitrogen-doped carbon spheres which form a working electrode of a sensing device. The sensing device exhibits a linear range of 1 μM to 3000 μM and 3000 μM to 7000 μM, with high sensitivity of 2024.18 μAmM⁻¹ cm⁻² and 1256.98 μAmM⁻¹ cm⁻² in the lower and higher concentration ranges, respectively. The detection limits corresponding to these ranges are 0.1 μM and 0.35 μM.

Another prior art [4] contributes to the fabrication of Ni₃N—Co₃N hybrid nanowires array. The array exhibited a linear range of 0.1 μM to 4.0 mM, high sensitivity of 4418.7 μAmM⁻¹ cm⁻², and a low detection limit of 30 nM.

In another prior art [5], Metal organic frameworks derived hybrid microspheres consisted of Ni₃N, and nitrogen-doped carbon were prepared by a facile in situ nitridation process. The as-prepared Ni₃N@C electrocatalysts display superior performance for non-enzymatic glucose sensing with two linear detection ranges. The sensitivity in the lower detection range (0.001 to 3 mM) is 1511.59 μAmM⁻¹ cm⁻² with detection limit of 0.3 μM. The sensitivity in higher detection range (3 to 7 mM) is calculated to be 783.75 μAmM⁻¹ cm⁻².

In another prior art [6], porous Ni₃N nanosheet arrays were used to modify glassy carbon electrodes, serving as the working electrode for a glucose-sensing device. The glucose-sensing device exhibits a linear sensing range of 2 μM to 7.5 mM, high sensitivity of 39 μAmM⁻¹ cm⁻², and a low detection limit of 0.48 μM.

In summary, the descriptions regarding the use of Ni₃N in sensor devices of the prior arts reveal that solution processes have been utilized to grow one-dimensional (nanowires) or two-dimensional (nanosheets) nanomaterials, or to grow nanometer or micrometer-sized spherical materials. However, due to the use of solution processes, the crystallinity, conductivity, and catalytic properties of the working electrodes still have significant room for improvement to further enhance the sensitivity and linear sensing range of glucose-sensing devices.

### SUMMARY OF THE INVENTION

Accordingly, one scope of the invention is to provide a glucose-sensing device and a method of fabricating the same. The glucose-sensing device, according to the invention, uses a transition metal nitride and has the advantages of higher sensitivity, a wider linear sensing range, and so on.

A glucose-sensing device according to a preferred embodiment of the invention includes an insulative substrate, a metal oxide conductive layer, a transition metal nitride layer, and an insulative layer. The insulative substrate has an upper surface. The metal oxide conductive layer is formed on the upper surface of the insulative substrate. The metal oxide conductive layer has a working electrode area and a terminal area. The transition metal nitride layer is locally formed to overlay the working electrode area of the metal oxide conductive layer. The insulative layer is locally formed on the metal oxide conductive layer such that the transition metal nitride layer and the terminal area of the metal oxide conductive layer are exposed

A method, according to a preferred embodiment of the invention, of fabricating a glucose-sensing device is, firstly, to prepare an insulative substrate. The insulative substrate has an upper surface. Then, the method according to the preferred embodiment of the invention is to form a metal oxide conductive layer on the upper surface of the insulative substrate. The metal oxide conductive layer has a working electrode area and a terminal area. Next, the method according to the preferred embodiment of the invention is, by a high-power impulse magnetron sputtering (HiPIMS) process, to locally form a transition metal nitride layer to overlay the working electrode area of the metal oxide conductive layer. Finally, the method according to the preferred embodiment of the invention is to locally form an insulative layer on the metal oxide conductive layer such that the transition metal nitride layer and the terminal area of the metal oxide conductive layer are exposed.

In one embodiment, the transition metal nitride layer can be formed of a nickel nitride, a copper nitride, a chromium nitride, a molybdenum nitride, an iron nitride, a cobalt nitride, and so on.

In one embodiment, the metal oxide conductive layer can be formed of an indium-doped tin oxide (ITO), a fluorine-doped tin oxide (FTO), an indium-doped zinc oxide (IZO), an indium oxide (InO), a tin oxide (SnO), an antimony-doped tin oxide (ATO), a cadmium tin oxide (CTO), an aluminum zinc oxide (AZO), an a gallium zinc oxide (GZO), and so on.

In one embodiment, the insulative substrate can be formed of a glass, a ceramic, a polymer, a semiconductor, and so on.

Distinguishable from the prior arts, the glucose-sensing device according to the invention uses a transition metal nitride and has the advantages of higher sensitivity, a wider linear sensing range, satisfactory selectivity, reproducibility, repeatability, operational stability, and so on.

The advantage and spirit of the invention may be understood by the following recitations together with the appended drawings.

### BRIEF DESCRIPTION OF THE APPENDED DRAWINGS

FIG. 1 is a top view of the final product of the glucose-sensing device according to a preferred embodiment of the invention

FIG. 2 is a cross-sectional view along line A-A of the final product of the glucose-sensing device shown in FIG. 1.

FIGS. 3, 4 and 5 are top views of the structures obtained at different stages of a method, according to the preferred embodiment of the invention, of fabricating the glucose-sensing device as shown in FIG. 1.

FIG. 6 shows the X-ray Diffraction (XRD) spectra of NiₓN films deposited in an example of the invention under different nitrogen flow ratios.

In FIG. 7, (a)-(e) show the field emission scanning electron microscope (FESEM) photographs of films deposited in the example of the invention with varying nitrogen flow ratios.

FIGS. 8(a), 8(b), 8(c), 8(d), 8(e), and 8(f) show the electrochemical response results of unmodified ITO electrodes and Ni₃N-modified ITO electrodes deposited in the example of the invention with varying nitrogen flow ratios, using cyclic voltammetry (CV) in 0.1 M NaOH solution with and without glucose at a scan rate of 50 mV/s.

FIG. 9 shows the relationship between the oxidation peak current and the concentration of glucose measured by cyclic voltammetry analysis of Ni₃N/ITO electrodes obtained by deposition of Ni₃N films deposited at 60% nitrogen flow ratio in 0.1 M NaOH with the addition of glucose at concentrations ranging from 100 μM to 1,000 μM at a scan rate of 50 mV/s, respectively.

FIG. 10 shows the oxidation peak current versus scan rate plots of Ni₃N/ITO electrodes obtained by depositing Ni₃N films at 60% nitrogen flow ratio in 0.1 M NaOH and analyzed by cyclic voltammetry at different scan rates (10~300 mV/s) in 100 μM glucose.

FIG. 11 shows the steady state response current versus the concentration of glucose as a function of amperometric (i-t) measurements of the potential dependence of the bare ITO electrode and the modified ITO electrodes with Ni₃N thin films deposited at 60% nitrogen flow ratio by modifying the concentration of glucose in 0.1 M NaOH solution at 0.56V.

FIG. 12 shows the result of cyclic voltammetry measurement of Ni₃N/ITO electrodes according to the invention to record the oxidation peak current after several days.

FIG. 13 shows the oxidation peak current results of five Ni₃N/ITO electrodes fabricated according to the invention under the same conditions and measured by cyclic voltammetry.

FIG. 14 shows the result of i-t measurement of Ni₃N/ITO electrodes according to the invention by adding two spikes of 200 μM glucose in 0.1 M NaOH for 3000 sec.

FIG. 15 shows the result of i-t measurement of Ni₃N/ITO electrode according to the present invention by adding three spikes of 100 μM glucose in 0.1 M NaOH solution.

### DETAILED DESCRIPTION OF THE INVENTION

Some preferred embodiments and practical applications of this present invention would be explained in the following paragraph, describing the characteristics, spirit, and advantages of the invention.

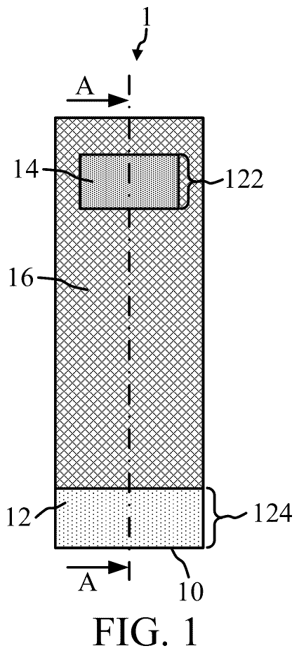

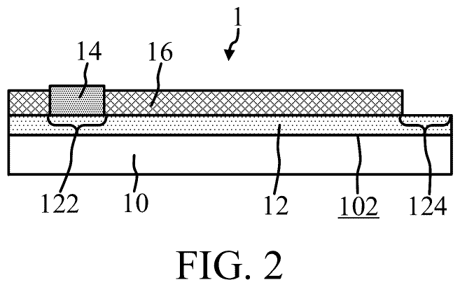

Referring to FIG. 1 and FIG. 2, those drawings schematically illustrate a glucose-sensing device 1 according to the preferred embodiment of the invention. FIG. 1 schematically illustrates with a top view the final product of the glucose-sensing device 1 according to the preferred embodiment of the invention. FIG. 2 is a cross-sectional view along line A-A of the final product of the glucose-sensing device shown in FIG. 1.

As shown in FIG. 1 and FIG. 2, the glucose-sensing device 1 according to the preferred embodiment of the invention includes an insulative substrate 10, a metal oxide conductive layer 12, a transition metal nitride layer 14, and an insulative layer 16.

Also as shown in FIG. 1 and FIG. 2, the insulative substrate 10 has an upper surface 102. The metal oxide conductive layer 12 is formed on the upper surface 102 of the insulative substrate 10. The metal oxide conductive layer 12 has a working electrode area 122 and a terminal area 124. The transition metal nitride layer 14 is locally formed to overlay the working electrode area 122 of the metal oxide conductive layer 12. The insulative substrate 10 is locally formed on the metal oxide conductive layer 12 such that the transition metal nitride layer 14 and the terminal area 124 of the metal oxide conductive layer 12 are exposed

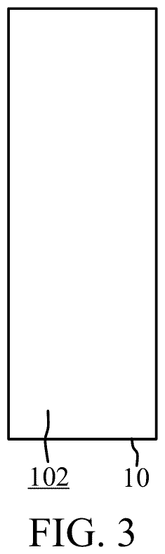

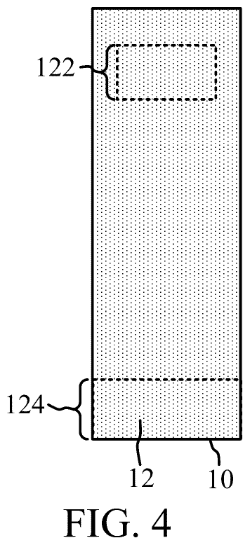

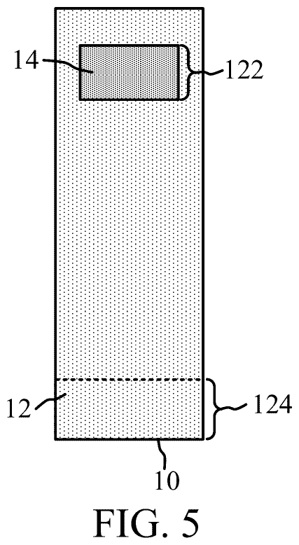

Referring to FIG. 3, FIG. 4 and FIG. 5, those figures illustratively show the structures obtained at different stages of a method, according to the preferred embodiment of the invention, of fabricating the glucose-sensing device 1 as shown in FIG. 1 with top views.

As shown in FIG. 3, the method, according to the preferred embodiment of the invention, of fabricating a glucose-sensing device 1 is, firstly, to prepare an insulative substrate 10. The insulative substrate 10 has an upper surface 102.

Then, as shown in FIG. 4, the method according to the preferred embodiment of the invention is to form a metal oxide conductive layer 12 on the upper surface 102 of the insulative substrate 10. The metal oxide conductive layer 12 has a working electrode area 122 and a terminal area 124.

Next, as shown in FIG. 5, the method according to the preferred embodiment of the invention is, by a high-power impulse magnetron sputtering (HiPIMS) process, to locally form a transition metal nitride layer 14 to overlay the working electrode area 122 of the metal oxide conductive layer 12.

Finally, the method according to the preferred embodiment of the invention is to locally form an insulative layer 16 on the metal oxide conductive layer 12, such that the transition metal nitride layer 14 and the terminal area 124 of the metal oxide conductive layer 12 are exposed, to finish the glucose-sensing device 1 as shown in FIG. 1.

In one embodiment, the transition metal nitride layer 14 can be formed of a nickel nitride, a copper nitride, a chromium nitride, a molybdenum nitride, an iron nitride, a cobalt nitride, or other transition metal nitrides.

In one embodiment, the metal oxide conductive layer 12 can be formed of an indium-doped tin oxide (ITO), a fluorine-doped tin oxide (FTO), an indium-doped zinc oxide (IZO), an indium oxide (InO), a tin oxide (SnO), an antimony-doped tin oxide (ATO), a cadmium tin oxide (CTO), an aluminum zinc oxide (AZO), an a gallium zinc oxide (GZO), or other metal oxides.

In one embodiment, the insulative substrate 10 can be formed of a glass, a ceramic, a polymer, a semiconductor, and so on.

In one example, the method according to the preferred embodiment of the invention uses a glass substrate and is to form an indium tin oxide (ITO) layer on the glass substrate. The film resistance of the ITO layer is 8Ω/□. The ITO layer thereon defines a working electrode area (0.3 cm×0.3 cm) and terminal area. Next, the method according to the preferred embodiment of the invention is to deposit a NiₓN thin film on the working electrode area of the ITO layer by a HiPIMS process. In the HiPIMS process, a pure nickel (purity 99.99%) target is used, and the power is supplied by a pulsed power supply with an average power of 300 W. During the deposition process of the NiₓN thin film, argon and nitrogen are utilized as non-reactive and reactive gas blends, respectively, with a constant working pressure of 0.67 Pa. The overall gas flow (Qₜₒₜ) is maintained at 20 sccm, and the nitrogen flow (Q_{N}_{₂}) and the argon flow (Q_{Ar}) are varied. The pulse-on time (ton) and pulse-off time (t_{off}) are maintained at 50/1000 μs, and the duty cycle, which is defined as [tₒₙ/(tₒₙ+t_{off})]×100% is kept around 4.76%. The nitrogen flow ratio (f_{N}_{₂}) is controlled by the nitrogen flow (Q_{N}_{₂}), calculated as [Q_{N}_{₂}/(Q_{N}_{₂}+Q_{Ar})]×100%.

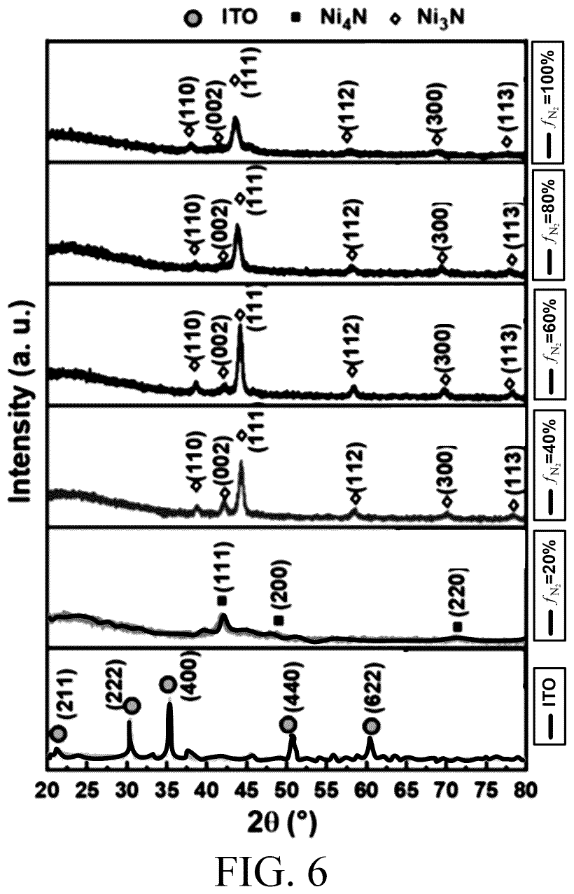

Referring to FIG. 6, FIG. 6 shows the X-ray diffraction (XRD) analysis results of the NiₓN thin film fabricated at different nitrogen flow ratios (f_{N}_{₂}) according to the example of the present invention. The X-ray diffraction data in FIG. 6 shows that the film is a pure Ni₃N phase, with a space group of P6322 (182) (PDF card number: 10-0280). The diffraction peaks are located around 38.58°, 42.24°, 44.30°, 58.53°, 69.84°, and 78.37°, confirming the hexagonal planes (110), (002), (111), (112), (300), and (113) of the Ni₃N crystal structure. By varying the nitrogen flow ratio from 20% to 100%, the crystal structure of the thin film changes from Ni₄N to Ni₃N. The film deposited at 60% nitrogen flow ratio exhibits the highest crystallinity. At 20% nitrogen flow ratio, the lower nitrogen content results in the formation of the Ni₄N phase, while at 40% nitrogen flow ratio, the Ni₄N phase transforms into the Ni₃N phase. A further increase in the nitrogen flow ratio provides enough nitrogen to react fully with the sputtered nickel atoms or ions to form the Ni₃N phase. When the nitrogen flow ratio is further increased (80%, 100%), the film retains the Ni₃N phase structure; however, its crystallinity begins to decrease.

Referring to FIG. 7, (a)-(e) show field emission scanning electron microscope (FESEM) photographs of the thin films deposited with varying nitrogen flow ratios. Uniformly distributed spherical particles can be observed in these photographs. When the nitrogen flow ratio increases from 40% to 60%, the thin film achieves a Ni₃N-dominated phase structure at 60% nitrogen flow ratio. Due to the formation of clustered structures, the particle size increases at 60% nitrogen flow ratio. Further increases in nitrogen flow ratio decrease the crystallinity of the Ni₃N thin film, with an increased nitrogen content leading to the suppression of particle growth. All thin films show small particle sizes within the nanometer range and have dense morphology. Subsequently, the deposited thin films are measured by an atomic force microscopy (AFM) to examine surface morphology and roughness. In FIG. 7, the thin film corresponding to (a) measured by the AFM has an average roughness (Rₐ) of 3.49 nm; (b) has an Rₐ of 2.57 nm; (c) has an Rₐ of 4.33 nm; (d) has an Rₐ of 2.32 nm; and (e) has an Rₐ of 2.09 nm. The thin film deposited at 60% nitrogen flow ratio has the highest roughness among all films, consistent with the XRD and FESEM data, exhibiting the highest crystallinity and particle size.

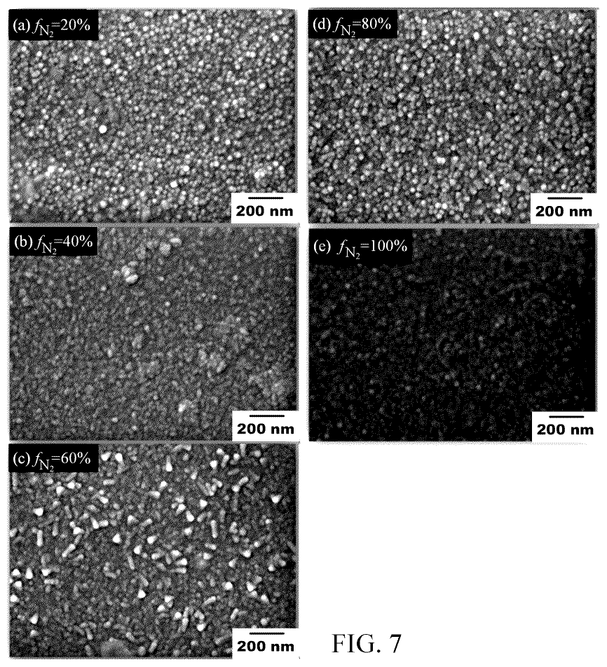

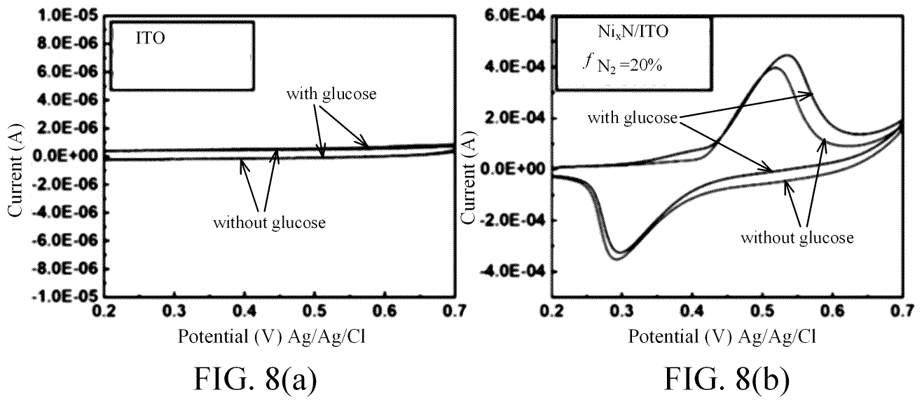

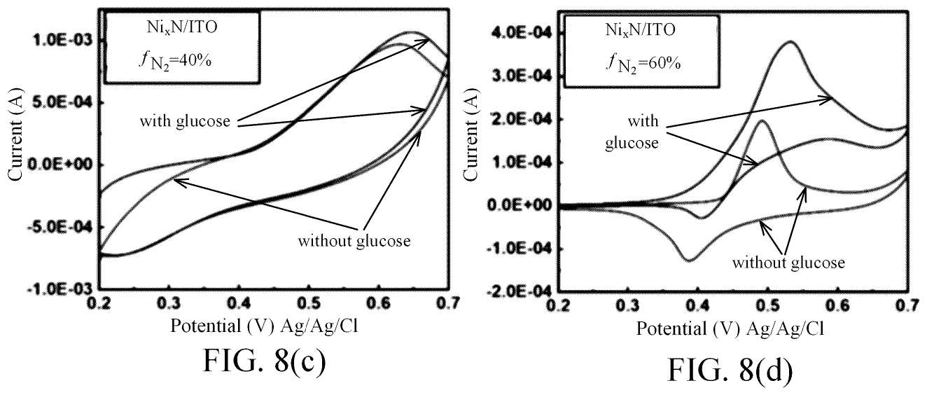

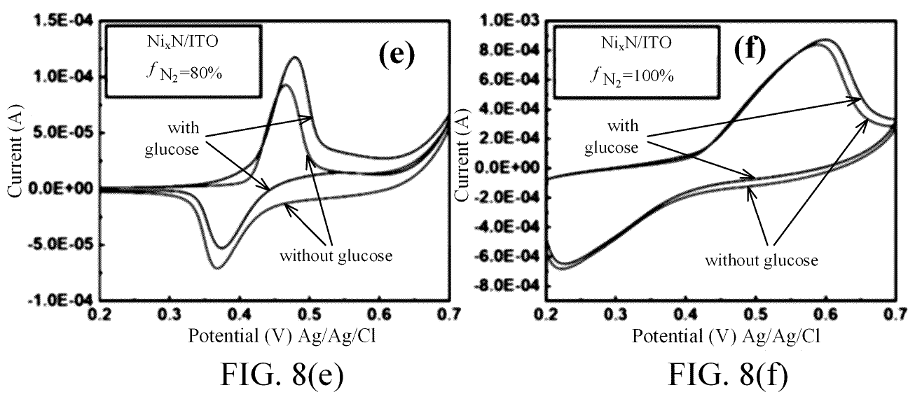

Referring to FIGS. 8(a), 8(b), 8(c), 8(d), 8(e), and 8(f), these figures show the electrochemical response results of unmodified ITO electrodes and Ni₃N-modified ITO electrodes deposited at different nitrogen flow ratios, using cyclic voltammetry (CV) in 0.1 M NaOH solution with and without glucose at a scan rate of 50 mV/s, to test the electrocatalytic properties of Ni₃N/ITO electrodes and unmodified ITO electrodes. For the unmodified ITO electrodes (as shown in FIG. 8(a)), there is no current response in 0.1 M NaOH solution with and without glucose. After modifying the ITO electrodes with Ni₃N thin films based on different nitrogen flow ratios, in the absence of glucose, redox peaks appear in 0.1 M NaOH solution at a scan rate of 50 mV/s, such as in FIG. 8(b) Ni₃N/ITO (20% nitrogen flow ratio), FIG. 8(c) Ni₃N/ITO (40% nitrogen flow ratio), FIG. 8(d) Ni₃N/ITO (60% nitrogen flow ratio), FIG. 8(e) Ni₃N/ITO (80% nitrogen flow ratio), FIG. 8(f) Ni₃N/ITO (100% nitrogen flow ratio). After modifying the ITO electrodes with Ni₃N thin films based on different nitrogen flow ratios and adding glucose, the oxidation peak current increases in 0.1 M NaOH solution at a scan rate of 50 mV/s. Therefore, Ni₃N exhibits enzyme-like properties. However, compared to the situation without glucose, the electrode that shows the best response in glucose is the Ni₃N thin film deposited at 60% nitrogen flow ratio. To understand the response of the modified electrodes to glucose oxidation, the following chemical reactions can be used to explain. During the CV scan in 0.1 M NaOH, the Ni₃N/ITO electrode surface may be covered with a layer of Ni(OH)₂ [Reaction (1)]. Further oxidation of Ni(OH)₂ can obtain NiOOH [Reaction (2)]. Finally, NiOOH oxidizes glucose to gluconolactone, while it is reduced back to Ni(OH)₂ itself [Reaction (3)]. The above reactions are represented as follows:

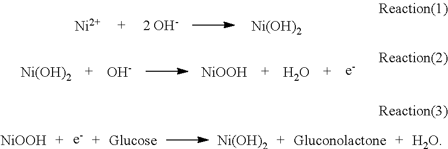

Cyclic voltammetry analysis confirms that the Ni₃N/ITO electrode with Ni₃N thin films deposited at 60% nitrogen flow ratio exhibited the best catalytic properties. Electrochemical impedance spectroscopy (EIS) further revealed that the Ni₃N/ITO electrode with Ni₃N thin films deposited at 60% nitrogen flow ratio demonstrated the best conductivity.

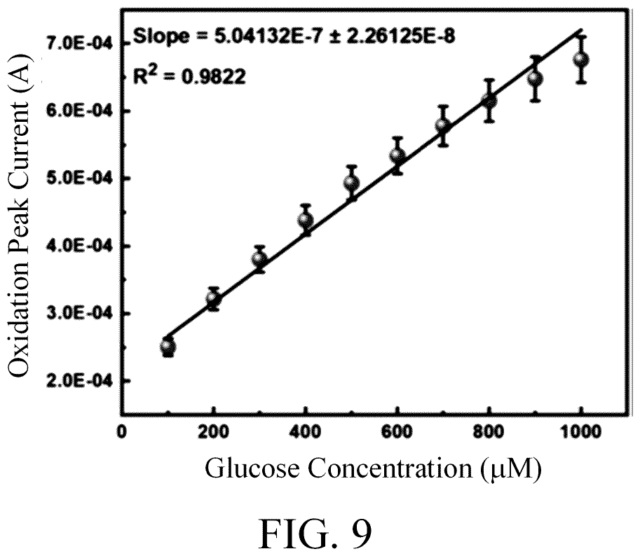

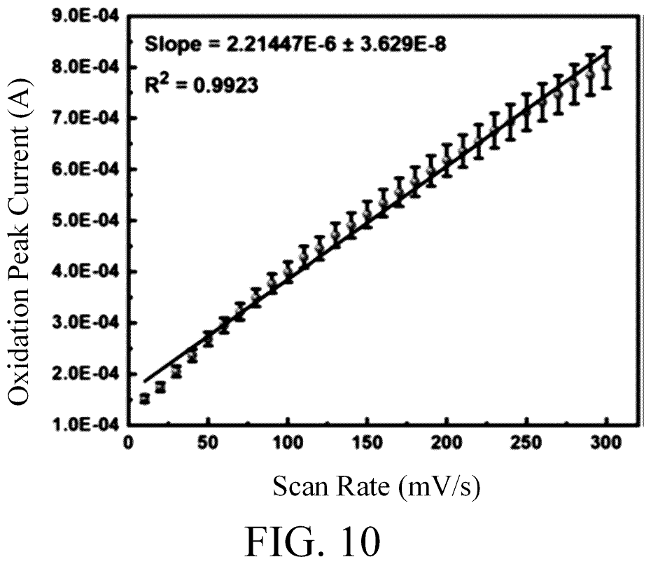

Referring to FIG. 9, FIG. 9 shows the relationship between oxidation peak current and glucose concentration measured by cyclic voltammetry after adding glucose concentrations ranging from 100 μM to 1000 μM in 0.1 M NaOH at a scan rate of 50 mV/s, using the Ni₃N/ITO electrode obtained by depositing Ni₃N thin films at 60% nitrogen flow ratio. FIG. 9 shows a good linear relationship between current response and glucose concentration, indicating that the Ni₃N/ITO electrode is a promising candidate material for non-enzymatic glucose sensing applications. Referring to FIG. 10, FIG. 10 shows the relationship between oxidation peak current and scan rate at different scan rates (10~300 mV/s) in 100 μM glucose in 0.1 M NaOH, measured by cyclic voltammetry using the Ni₃N/ITO electrode obtained by depositing Ni₃N thin films at 60% nitrogen flow ratio. The linear relationship between oxidation current response and scan rate in FIG. 10 indicates a diffusion-controlled process on the Ni₃N/ITO electrode.

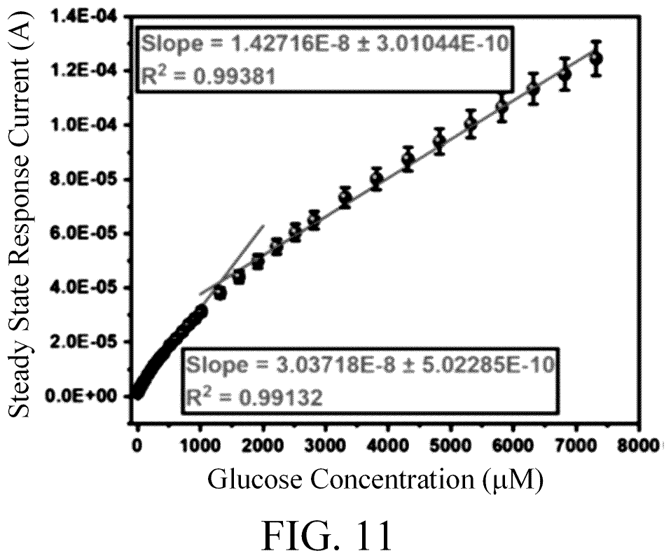

Referring to FIG. 11, FIG. 11 shows the steady-state response current versus glucose concentration measured by potential-dependent amperometric (i-t) measurements in 0.1 M NaOH solution by modulating the glucose concentration using bare ITO electrodes and Ni₃N thin film (deposited at 60% nitrogen flow ratio) modified ITO electrodes. The i-t measurement experiment confirmed that there was no current response with the bare ITO electrodes. FIG. 11 shows a linear current response with the Ni₃N/ITO electrode. This experiment confirms that the Ni₃N/ITO electrode according to the invention is a potential high-efficiency non-enzymatic glucose sensor.

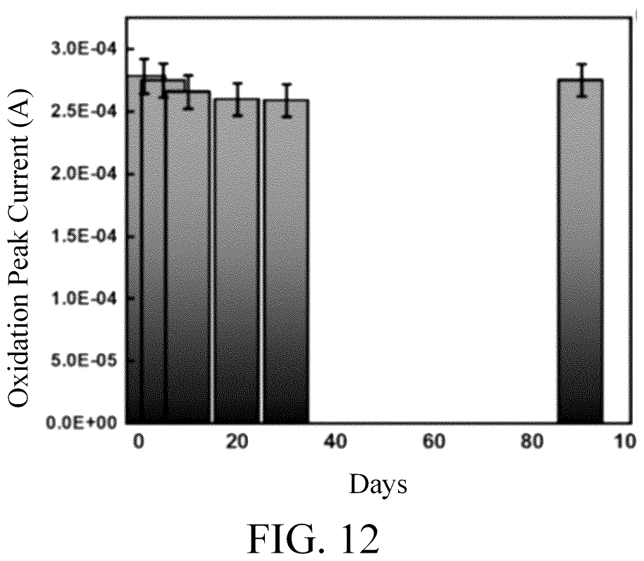

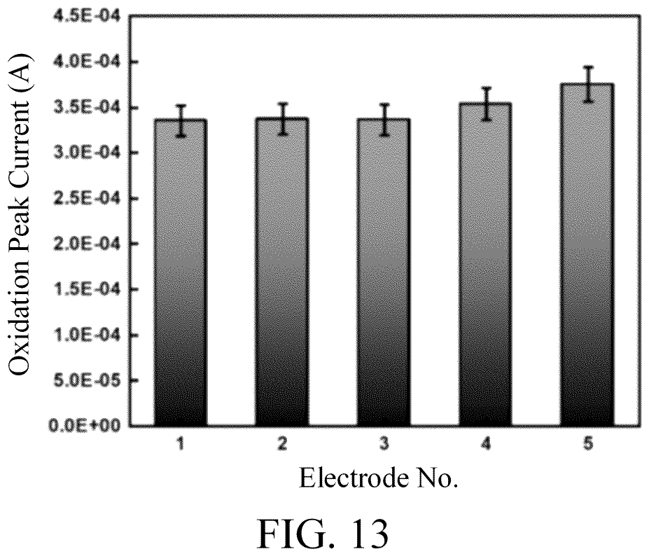

The efficiency evaluation of the glucose-sensing device according to the invention is based on the repeatability, reproducibility, and operational stability of the electrodes. Referring to FIG. 12, FIG. 12 shows the peak current results measured by cyclic voltammetry over several days using the Ni₃N/ITO electrode according to the invention. FIG. 12 confirms the high repeatability of the working electrode of the glucose-sensing device according to the invention. After 90 days of measurement, the working electrode of the glucose-sensing device according to the invention maintains 98.9% of the initial current response. Referring to FIG. 13, FIG. 13 shows the peak current results measured by cyclic voltammetry for five Ni₃N/ITO electrodes manufactured under the same conditions to verify the reproducibility of the electrodes. FIG. 13 shows that the current responses of all electrodes are almost identical, confirming the high reproducibility of the Ni₃N/ITO electrodes according to the invention.

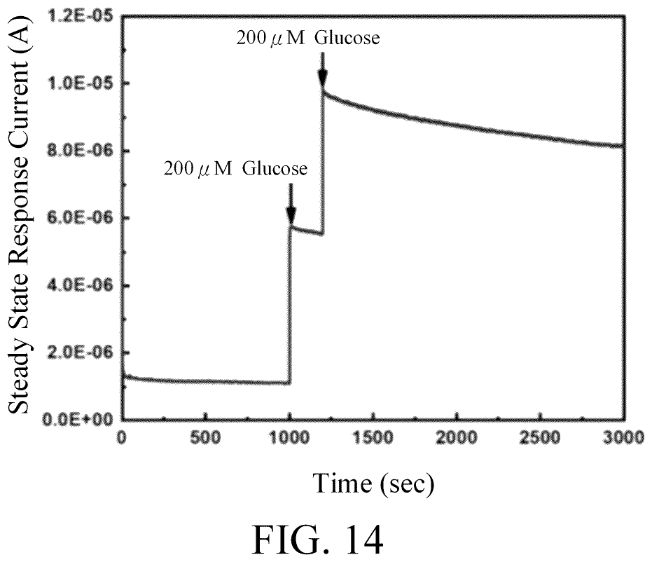

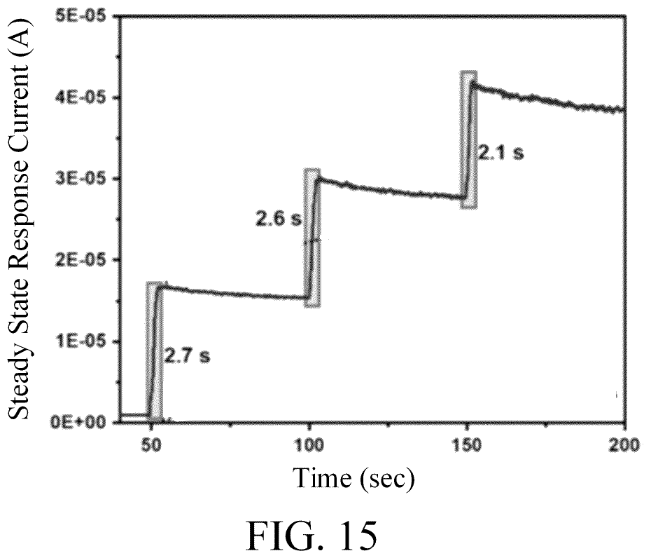

Referring to FIG. 14, FIG. 14 shows the results of an i-t measurement for 3000 seconds by adding two 200 μM glucose spikes in 0.1 M NaOH based on the Ni₃N/ITO electrode of the present invention. FIG. 14 shows that the current response after 3000 seconds is 83.76% of the original value, meaning that the current only decreased by 16.24% after 3000 seconds. Thus, it can be explained that the Ni₃N/ITO electrode of the invention has stability for long-term operation. Referring to FIG. 15, FIG. 15 shows the results of an i-t measurement by adding three 100 μM glucose spikes in 0.1 M NaOH solution based on the Ni₃N/ITO electrode of the invention. FIG. 15 shows that the average response time of the Ni₃N/ITO electrode to glucose is 2.46 seconds.

In addition, the Ni₃N/ITO electrode of the invention also conducted amperometric response measurements for known concentrations of saliva and urine and obtained their corresponding calibration curves. Therefore, the glucose-sensing device of the invention can be applied to the measurement of concentrations in saliva, urine, and other similar fluids. Furthermore, the Ni₃N/ITO electrode of the present invention also performed amperometric response measurements for unknown concentrations of honey and apple juice and obtained their corresponding calibration curves. Consequently, the glucose-sensing device of the invention can be utilized for the measurement of concentrations in saliva, urine, and similar fluids as well as the dosage of honey, apple juice, and other similar substances.

The sensitivity and limit of detection (LOD) of the glucose sensor element according to the invention are calculated using the following formulas:

$$sensitivity ( μ A {mM}^{- 1} {cm}^{- 2} ) = Δ I ( μ A ) [ Δ c ( mM ) \cdot A ( {cm}^{2} ) ] \qquad formula ( 1 )$$

where ΔI is the change in current, Δc is the change in glucose concentration, and A is the area of the electrode,

$$L O D = 3 σ / S \qquad formula ( 2 )$$

where σ is the standard deviation of the noise, and S is the slope of the linear calibration curve.

Based on the above measurements, it is evident that the glucose-sensing device according to the invention, which uses a thin film of Ni₃N, and other transition metal nitrides deposited on a conductive layer of indium-doped tin oxide (ITO) or other metal oxides as the working electrode, performs non-enzymatic glucose detection in alkaline media by electrochemical methods. The thin film of transition metal nitrides, such as Ni₃N, is deposited using HiPIMS as the deposition technique due to the high ionization rate of the sputtered species and high-density plasma, which facilitates the reaction between Ni ions and nitrogen to form the ideal Ni₃N phase. Additionally, this method supports sustainable manufacturing as a green process. The glucose-sensing device according to the invention has a lower linear range of 0.001-1.25 mM, with a sensitivity and limit of detection of 337.46 μAmM⁻¹ cm⁻² and 0.78 μM, respectively; and a higher linear range of 1.25-7.3161 mM, with a sensitivity of 158.58 μAmM⁻¹ cm⁻². Amperometric measurements show that the glucose sensing element according to the present invention has a fast response time to glucose detection, with an average response time of 2.46 seconds. Based on the corresponding measurements, the key parameters of the glucose sensing element according to the present invention include satisfactory selectivity, reproducibility, repeatability, and operational stability. The glucose sensing element according to the present invention also exhibits significant responses to real samples, such as commercially available honey, apple juice, and biological fluids.

With the examples and explanations described above, the characteristics and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A glucose-sensing device, comprising:
an insulative substrate, having an upper surface;
a metal oxide conductive layer, being formed on the upper surface of the insulative substrate and having a working electrode area and a terminal area;
a transition metal nitride layer, locally formed to overlay the working electrode area of the metal oxide conductive layer; and
an insulative layer, locally formed on the metal oxide conductive layer such that the transition metal nitride layer and the terminal area are exposed.

2. The glucose-sensing device of claim 1, wherein the transition metal nitride layer is formed of one selected from the group consisting of a nickel nitride, a copper nitride, a chromium nitride, a molybdenum nitride, an iron nitride, and a cobalt nitride.

3. The glucose-sensing device of claim 1, wherein the metal oxide conductive layer is formed of one selected from the group consisting of an indium-doped tin oxide (ITO), a fluorine-doped tin oxide (FTO), an indium-doped zinc oxide (IZO), an indium oxide (InO), a tin oxide (SnO), an antimony-doped tin oxide (ATO), a cadmium tin oxide (CTO), an aluminum zinc oxide (AZO), and an a gallium zinc oxide (GZO).

4. The glucose-sensing device of claim 1, wherein the insulative substrate is formed of one selected from the group consisting of a glass, a ceramic, a polymer, and a semiconductor.

5. A method of fabricating a glucose-sensing device, comprising the steps of:
preparing an insulative substrate having an upper surface;
forming a metal oxide conductive layer on the upper surface of the insulative substrate, wherein the metal oxide conductive layer has a working electrode area and a terminal area;
by a high-power impulse magnetron sputtering (HiPIMS) process, locally forming a transition metal nitride layer to overlay the working electrode area of the metal oxide conductive layer; and
locally forming an insulative layer on the metal oxide conductive layer such that the transition metal nitride layer and the terminal area are exposed.

6. The method of claim 5, wherein the transition metal nitride layer is formed of one selected from the group consisting of a nickel nitride, a copper nitride, a chromium nitride, a molybdenum nitride, an iron nitride, and a cobalt nitride.

7. The method of claim 5, wherein the metal oxide conductive layer is formed of one selected from the group consisting of an indium-doped tin oxide (ITO), a fluorine-doped tin oxide (FTO), an indium-doped zinc oxide (IZO), an indium oxide (InO), a tin oxide (SnO), an antimony-doped tin oxide (ATO), a cadmium tin oxide (CTO), an aluminum zinc oxide (AZO), and an a gallium zinc oxide (GZO).

8. The method of claim 5, wherein the insulative substrate is formed of one selected from the group consisting of a glass, a ceramic, a polymer, and a semiconductor.
